(19) United States
(12) Patent Application Publication
(10) Pub. No.: US 2024/0380281 A1
(43) Pub. Date: Nov. 14, 2024

(54) ELECTRIC MACHINE FLUID COOLING SYSTEM WITH AIR VENT

(71) Applicant: Dana Automotive Systems Group, LLC, Maumee, OH (US)

(72) Inventors: Jaywant S. PAWAR, Pune (IN); Steven VANHEE, Hooglede (BE); Maarten DEBROUWERE, Zeldgem (BE); Sam LEROY, Gent (BE); Laurens VAN EYKEREN, Brugge (BE)

(21) Appl. No.: 18/657,507

(22) Filed: May 7, 2024

Related U.S. Application Data
(60) Provisional application No. 63/501,596, filed on May 11, 2023.

(51) Int. Cl. H02K 9/19; H02K 1/32; H02K 7/00; H02K 7/08; H02K 7/116

(52) U.S. Cl. CPC H02K 9/19; H02K 1/32; H02K 7/003; H02K 7/083; H02K 7/116

(57) ABSTRACT

Methods and systems are provided to cool an electric machine rotor. The electric machine fluid cooling system includes, in one example, an air vent in fluidic communication with a radial coolant passage of a rotor shaft. In the system, the radial coolant passage is in fluidic communication with a rotor shaft coolant passage that extends through a rotor shaft and an inlet coolant passage that extends through a rotor shaft.

### CROSS REFERENCE TO RELATED APPLICATION

The present application claims priority to U.S. Provisional Application No. 63/501,596, entitled “ELECTRIC MACHINE FLUID COOLING SYSTEM WITH AIR VENT”, and filed on May 11, 2023. The entire contents of the above-listed application are hereby incorporated by reference for all purposes.

### TECHNICAL FIELD

The present disclosure relates to an electric machine with a fluid cooling system that includes an air vent in a rotor shaft.

### BACKGROUND AND SUMMARY

Electric machines, such as electric motors, are used in vehicle powertrains and other systems to provide mechanical power to desired components. To increase electric motor efficiency and continuous performance in vehicle drive units and other systems, motors have made use of cooling systems that direct pressurized oil through channels in the rotor assembly. Cooling the rotor allows the motor's efficiency to be increased. Cooling systems may be particularly desirable in higher performance electric motors with comparatively high efficiency targets.

However, the inventors have recognized several issues with previous motor cooling assemblies. For instance, air may become trapped in certain areas of the rotor shaft cooling assembly. The trapped air may lead to unbalanced centrifugal pressure and therefore increase the pressure drop over a rotor shaft, particularly at higher shaft speeds. To elaborate, in some fluid cooling systems, air may become trapped in passages on an inlet side of the system, which increases pumping power demands in the fluid supply system (e.g., oil supply system). For instance, the air may be introduced into the system during fluid filling. Further, if a mixture of air and oil flows though the rotor, the motor's heat transfer performance may additionally be decreased.

The issues mentioned above may be addressed by an electric machine fluid cooling system. The fluid cooling system includes, in one example, an air vent in fluidic communication with an inlet side radial coolant passage. In the fluid cooling system, the radial coolant passage is in fluidic communication with a rotor shaft coolant passage that extends through a rotor shaft. Further, in the fluid cooling system, the radial coolant passage is in fluidic communication with an inlet coolant passage that extends through a rotor shaft. In this way, the air trapped in the fluid cooling system can be evacuated, thereby increasing electric machine performance.

Further in one example, the air vent may be in fluidic communication with a cavity that is positioned radially inward from a rotor shaft bearing. In this way, the working fluid (e.g., oil) which may be mixed with the air may be directed to the bearing for additional lubrication. For instance, the cooling system may further include a bearing nozzle that extends from the cavity to a bearing cavity that is axially adjacent to the rotor shaft bearing. In this way, the fluid which is mixed with the air that is removed from the radial coolant passage is directed to the rotor shaft bearing to increase bearing lubrication. Consequently, electric machine efficiency is further increased.

It should be understood that the summary above is provided to introduce in a simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a perspective view of an electric machine with a fluid cooling system.

FIG. 2 shows a detailed perspective view of the fluid cooling system in the electric machine rotor shaft depicted in FIG. 1.

FIG. 3 shows a detailed view of a portion of the fluid cooling system, depicted in FIG. 2.

FIG. 4 shows a cross-sectional view of the electric machine rotor shaft, depicted in FIG. 1.

FIG. 5 shows another view of the fluid cooling system, depicted in FIG. 2.

FIG. 6 shows exemplary computational fluid dynamics (CFD) models of working fluid and air in the fluid cooling system, depicted in FIG. 2.

FIG. 7 shows a cross-sectional view of another example of an electric machine with a fluid cooling system.

### DETAILED DESCRIPTION

The systems and methods described herein relate to an electric machine with a fluid cooling system that includes air vent passages which allow air (which is trapped in inlet side coolant passages of a rotor shaft) to be removed therefrom, thereby increasing the pressure in the cooling system. The air vent passages extend from radial coolant passages in a rotor shaft to a cavity (which may be positioned interior to a rotor shaft bearing). The air vent passages allow the concentration of air in the system's working fluid (e.g., oil) to be reduced to increase the amount of heat that can be removed from the electric machine and increase the cooling system's pumping efficiency.

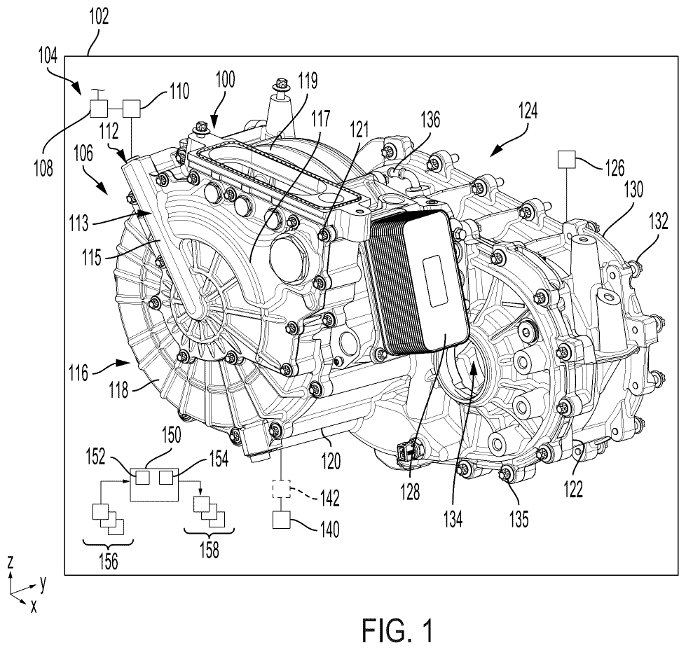

FIG. 1 shows an electric machine 100 (e.g., an electric motor, such as a motor-generator) which may be included in a system 102, such as an electric drive unit in an electric vehicle (EV). As such, the electric machine 100 may be designed to generate mechanical power, as well as electric power during a regeneration mode, in some cases. The electric drive unit may additionally include a gearbox, an inverter, and/or other suitable components, discussed in greater detail herein. In such examples, the vehicle may take a variety of forms in different embodiments, such as a light, medium, or heavy duty vehicle. Alternatively, the motor may be used in other suitable systems, such as systems in manufacturing facilities, other industrial settings, and the like.

In some examples, in addition to the electric machine 100, the vehicle may further include another motive power source, such as an internal combustion engine (ICE) (e.g., a spark and/or compression ignition engine) or other suitable devices to generate rotational energy. The ICE may include conventional components such as cylinders, pistons, valves, a fuel delivery system, an intake system, an exhaust system, and the like. Thus, in the vehicle example, the vehicle may be an EV, such as a hybrid electric vehicle (HEV) or an all-electric vehicle (e.g., battery electric vehicle (BEV)).

FIG. 1 further illustrates a fluid cooling system 104 for the electric machine 100 and specifically a rotor in the electric machine. In particular, the fluid cooling system is configured to remove heat from a rotor shaft and a lamination assembly, in some instances. The fluid cooling system 104 may include a cooling circuit 106 for cooling the electric machine. The cooling circuit 106 may be designed to circulate a working fluid, such as natural and/or synthetic oil, through the electric machine. However, another suitable working fluid may be used, in other examples.

The fluid cooling system 104 may include a filter 108 and a pump 110 (e.g., an oil pump). The pump 110 flows the working fluid to an inlet 112 of an inlet passage 113. In the illustrated example, the inlet passage 113 includes a radial section 115. However, other inlet passage contours may be used in other examples.

In one example, the pump 110 may be designed to pick up the working fluid from a sump (e.g., oil sump), which may be formed within a lower portion of a gearbox 124 of the electric drive unit. A housing 116 of the electric machine is further shown in FIG. 1. As illustrated, the pump 110 and the filter 108 may be disposed external to the housing 116. However, in other examples, the pump 110 and/or the filter 108 may be incorporated in the housing. The fluid cooling system 104 may further include a heat exchanger configured to decrease the temperature of the fluid circulating through the fluid cooling system 104.

The housing 116 may be divided into sections. To elaborate, an inlet side section 117 may be removably coupled to a housing body 119 via fasteners 121 or other suitable attachment devices. The inlet side section 117 includes the inlet passage 113, in the illustrated example. A heated exchanger 128 (e.g., a cooler) may be coupled to the housing body 119.

The housing 116 may include sections that are removably attached to one another. To elaborate, an inlet side cover 118 may be coupled (e.g., directly coupled) to a body 120 of the housing 116. The body 120 of the housing 116 may further be removably coupled (e.g., directly removably coupled) to a gearbox housing 122. The gearbox housing 122 may at least partially enclose a gearbox 124 which is rotationally coupled to the electric machine 100. However, the electric machine may be coupled to another suitable component, in other examples. In turn, the gearbox 124 may be coupled to a downstream component (e.g., an axle assembly, a drive shaft, and the like). The gearbox 124 may be rotationally coupled to a downstream component 126 such as a differential, a drive shaft, and the like. To elaborate, a housing of the downstream component 126 may be directly coupled to a flange 130 of the gearbox housing 122 using fasteners 132 and/or other suitable attachment devices. However, other powertrain architectures have been contemplated.

The electric machine housing 116 and specifically the housing body 119 includes on opening 134 for a gearbox output shaft, in the illustrated example. In this way, the space efficiency of the powertrain is increased. Further, the housing body 119 is coupled to the gearbox housing 122 vis fasteners 135, in the illustrated example. Further, the gearbox housing 122 includes a coolant outlet 136, in the illustrated example.

The electric machine 100 may be electrically coupled to an energy storage device 140 (e.g., a traction battery, fuel cells, capacitors, and the like) via an electrical interface such as a bus-bar or other suitable interface. The electric machine 100 may be a multi-phase electric machine (e.g., a three-phase machine, a six-phase machine, a nine-phase machine, etc.), in one example. In such an example, an inverter 142 may provide electrical energy to the electric machine 100 and receive electrical energy from the energy storage device 140. Multi-phase electric motors achieve greater efficiency than some direct current (DC) type motors. However, in other examples, the electric machine may be a DC electric machine.

A controller 150 may further be included in the system 102. The controller may include a processor 152 and memory 154 with instructions stored therein that, when executed by the processor, cause the controller to perform various methods and control techniques described herein. The processor may include a microprocessor unit and/or other types of circuits. The memory may include known data storage mediums, such as random access memory, read only memory, keep alive memory, combinations thereof, and the like.

The controller 150 may receive various signals from sensors 156 positioned in the system 102 and/or the electric machine 100. Conversely, the controller 150 may send control signals to various actuators 158 at different locations in the system based on the sensor signals. For instance, the controller 150 may send command signals to the pump 110, and, in response, the actuators in the pumps may be adjusted to alter the flowrate of the fluid delivered therefrom. In other examples, the controller may send control signals to an inverter coupled to the electric machine 100 and in response to receiving the command signals, the inverter may be adjusted to alter electric machine speed. Other controllable components in the system may be operated in a similar manner with regard to sensor signals and actuator adjustment.

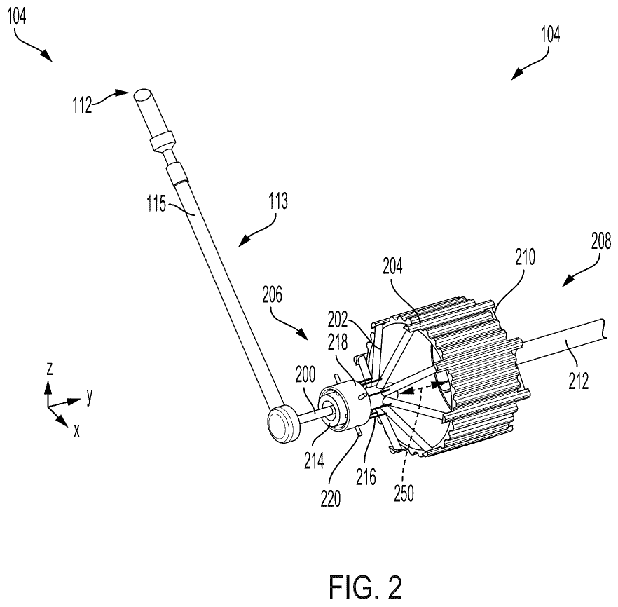

An axis system is provided in FIG. 1, as well as in FIGS. 2-7, for reference. The z-axis may be a vertical axis (e.g., parallel to a gravitational axis), the x-axis may be lateral axis (e.g., a horizontal axis), and/or the y-axis may be a longitudinal axis, in one example. However, the axes may have other orientations, in other examples.

FIG. 2 shows a detailed view of coolant passages in the fluid cooling system 104. Various electric machine components are omitted from the illustration to reveal the cooling system architecture. To elaborate, the various passages, nozzles, and other components through which coolant flows are depicted. The structure around these passages is omitted to reveal the structural details of the coolant passages in the fluid cooling system.

In the illustrated example, the fluid cooling system 104 includes the inlet passage 113 with the inlet 112 that is in fluidic communication with an upstream component such as the pump 110, shown in FIG. 1, or another suitable component.

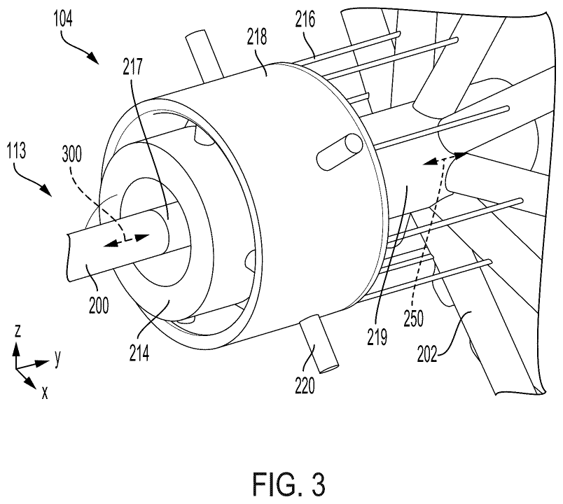

The inlet passage 113 may be conceptually divided into the radial section 115 and an axial section 200. A pressure sensor may be coupled to the inlet passage 113. The inlet passage 113 is further in fluidic communication (e.g., direct fluidic communication) with radial coolant passages 202 (e.g., radial rotor shaft coolant passages). The radial coolant passages 202 extend radially outward from the axial section 200 of the inlet passage 113. Further, the radial coolant passages 202 are angled with regard to a central axis 250 (which is the rotational axis of the electric machine during operation). The angle may be less than ninety degrees, in one example. However, in other examples, the angle may be thirty degrees. The central axis 250 is additionally depicted in FIGS. 3-6, for reference.

As shown in FIG. 2, the radial coolant passages 202 may be symmetrically distributed about the machine's central axis 250 and specifically a radial plane that intersects the axis 250. In this way, imbalances during rotor rotation are decreased. However, the radial coolant passages may not be equally distributed about the central axis.

The fluid cooling system 104 further includes rotor shaft coolant passages 204 (e.g., outer rotor shaft coolant passages) which are in fluidic communication with the radial coolant passages 202 (e.g., inlet side radial coolant passages). The rotor shaft coolant passages 204 extend through a rotor shaft to provide cooling thereto. To elaborate, each of the radial coolant passages may be in fluidic communication with one of the rotor shaft coolant passages 204. However, in alternate examples, each radial coolant passage may be coupled to two or more rotor shaft coolant passages or vice versa. Further, the rotor shaft coolant passages 204 are positioned radially outward from the radial coolant passages 202 and may specifically be positioned at an outer diameter of the rotor shaft. Positioning the rotor shaft coolant passages 204 in this manner allows the passages to have a larger contact area for cooling due to a comparatively thin sleeve of fluid (e.g., oil) being formed in the passages, for example, to decrease flow losses in the oil. The rotor shaft coolant passages 204 are axially aligned along their central axis in the illustrated example. Therefore, the rotor shaft coolant passages may specifically be axial coolant passages, in one example. The radial coolant passages 204 may have a greater diameter than inlet and outlet side coolant passages which are discussed in greater detail herein, in one example. In this way, rotor cooling (e.g., cooling of the rotor magnets) may be increased, when compared to smaller diameter passages.

The fluid cooling system 104 may be conceptually divided into an inlet side 206 and an outlet side 208. The fluid cooling system 104 may further include outlet side radial coolant passages 210 which are in fluidic communication with the rotor shaft coolant passages 204. The outlet side radial coolant passages 210 may be in fluidic communication with an outlet coolant passage 212. In turn, the outlet coolant passage 212 may be in fluidic communication with a downstream component such as the gearbox 124, depicted in FIG. 1, or another suitable downstream component.

The fluid cooling system 104 may further include a coolant leakage section 214 that circumferentially surrounds the axial section 200 of the inlet passage 113, as illustrated in FIG. 2. Air vents 216 are included in the fluid cooling system 104 and in fluidic communication with the radial coolant passages 202. To expound, in the illustrated example, each of the air vents 216 are in fluidic communication with one of the radial coolant passages 202. In this way, a desired amount of air may be removed from the radial coolant passages. However, in alternate examples, each of the air vents may be in fluidic communication with two or more of the radial coolant passages or vice versa. The air vents 216 may have straight shape that are parallel to the central axis 250 of the electric machine 100. In this way, losses in the air vents may be reduced when compared to vents with bends. However, in other examples, the air vents may be inclined in relation to the central axis. The air vents allow air that is trapped in the coolant passages to be removed to increase coolant pressure and electric machine performance, more generally.

The air vents may have a smaller diameter than the radial coolant passages 202 in the fluid cooling system 104 to allow a desired amount of air to be removed from the coolant passages and the coolant passages to achieve desired flow dynamics. In one specific use-case example, the diameter of the air vents may be 0.5 millimeters (mm). However, other suitable air vent diameters may be used in other examples and the air vent size may be selected based on the size of the electric machine, the expected operating speed of the machine, and/or other factors, for instance.

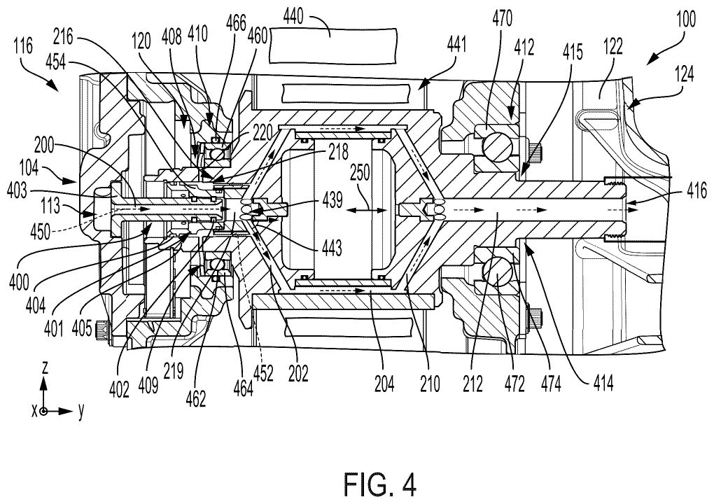

A section 217 of the inlet passage 113 may be formed from a static insert, expanded upon herein with regard to FIG. 4. A section 219 of the inlet passage 113 further functions as a distribution manifold for the radial coolant passages 202.

The air vents 216 may be in fluidic communication with a coolant cavity 218. The boundary of the coolant cavity 218 (discussed in greater detail herein) may be formed from an insert and a section of the rotor. The coolant cavity 218 is in fluidic communication (e.g., direct fluidic communication) with bearing nozzles 220. Further, the coolant cavity 218 is in fluidic communication with the coolant leakage section 214. However, the electric machine may be formed with another suitable housing construction, in other examples.

FIG. 3 shows a detailed view of the axial section 200 of the inlet passage 113, the radial coolant passages 202, the air vents 216, the coolant leakage section 214, the coolant cavity 218, and the bearing nozzles 220. The coolant leakage section 214 circumferentially encloses the inlet passage 113 and the coolant cavity 218 circumferentially encloses the coolant leakage section 214, in the illustrated example. However, other arrangements of the coolant leakage section, the coolant cavity, and the inlet passage are possible. The boundary of the coolant cavity 218 may be formed from at least a portion of an outer surface of a sleeve (discussed in greater detail herein with regard to FIG. 4) and a section of the rotor. In the illustrated example, a central axis 300 of the axial section 200 of the inlet passage 113 is coaxial to the machine's rotational axis 250. However, other contours of the inlet passage are possible.

The bearing nozzles 220 may be radially aligned. Aligning the bearing nozzles in this manner allows centrifugal forces to effectively deliver oil to a rotor shaft bearing which is expanded upon herein. Further, the bearing nozzles may be symmetrically distributed around the insert. The rotational axis 250 of the rotor is provided in FIG. 3, for reference. The bearing nozzles 220 are also expanded upon herein with regard to FIG. 4.

The coolant cavity 218 is illustrated with an annular shape having a constant inner diameter and an outer diameter along its length. However, it will be appreciated that the coolant cavity 218 may have another suitable shape such as a shape with a first section with a wider inner diameter which is adjacent to the bearing nozzles 220 and a second section with a smaller inner diameter which is outboard of the first section. Additionally, the inlet passage 113 is positioned in the rotor shaft to allow coolant to be efficiently routed through the electric machine.

FIG. 4 shows a cross-sectional view of the electric machine 100 with the fluid cooling system 104. The inlet passage 113 in the fluid cooling system 104 is again shown. Specifically, the axial section 200 of the inlet passage 113 is depicted in FIG. 4. A static component (e.g., a static lance) 400 may form a portion of the inlet passage 113. A rotating insert 401 is coupled to the static component 400. A head 403 of the insert 401 may be in contact with the housing 116 to enable the coolant from the radial section 115 (shown in FIG. 1) of the inlet passages 113 to be directed into the axial section 200 of the inlet passage.

Seals 402 may specifically be provided at the interface between the static component 400 and the insert 401. The seals 402 may specifically be rotary seals such as labyrinth seals. Further, seals 404 may be positioned at the interface between the insert 401 and a section 405 of a rotor 415. In this way, coolant leakage in the system is reduced (e.g., avoided).

The coolant cavity 218 may be formed between the insert 401 and the rotor section 405. The bearing nozzles 220 are shown extending from the coolant cavity 218 to a bearing cavity 408 which is axially adjacent to a bearing 410 (e.g., an inlet side bearing). However, other bearing nozzle positions have been contemplated. To elaborate, the bearing cavity 408 may be on the outboard side 409 of the bearings 410. The bearing 410 may include an outer race 460, roller elements 462 (e.g., spherical balls, cylindrical rollers, tapered cylindrical rollers, and the like), and an inner race 464. A seal 466 may be positioned between the bearing 410 and the section 120 of the housing 116.

FIG. 4 further shows an outlet side bearing 412 coupled to a rotor shaft 414 (e.g., an outlet side rotor shaft section) in the rotor 415. The outlet side bearing 412 includes an outer face 470, roller elements 472 (e.g., spherical balls, cylindrical rollers, tapered cylindrical rollers, and the like), and an inner race 474. The outlet side bearing 412 may be arranged adjacent to the gearbox. Consequently, splash lubrication within the gearbox may keep the outlet side bearing lubricated.

Further, a portion of the rotor shaft 414 may extend through the housing section 120 as well as the gearbox housing 122 and includes an outlet 416 that may be in fluidic communication with coolant passages in the gearbox 124. However, other fluid cooling system designs may be used with different fluid routing at the outlet, in alternate embodiments.

Arrows 450 indicate the general direction of oil flow through the fluid cooling system 104 during operation. To elaborate, oil first flows through the inlet passage 113 to the radial coolant passages 202 (e.g., inlet side radial coolant passages), from the radial coolant passages 202 to the rotor shaft coolant passages 204, from the rotor shaft coolant passages 204 to the outlet side radial coolant passages 210, from the outlet side radial coolant passages 210 to the outlet passage 212, and from the outlet passage 212 to a downstream component such as the gearbox 124. The inlet side radial coolant passages 202 and the outlet side radial coolant passages 210 may be symmetric about a plane that is normal to the machine's rotational axis. The symmetric design of the radial coolant passages increases pressure recovery and reduces pumping power demands in the coolant supply system.

Arrows 452 indicate the general direction of airflow through the air vents 216 in the fluid cooling system 104. The air in the air vents 216 flows into the cavity 406 and then through the bearing nozzles 220 to the bearing cavity 408.

The section 219 of the inlet passage 113 is depicted in FIG. 4 which functions as a distribution manifold for the radial coolant passages 202. Specifically, inlets 439 of the radial coolant passages 202 are depicted in FIG. 4. The radial coolant passages 202 form an angle 443 with regard to a longitudinal axis which is parallel to the axis 250. The angle 443 may be in the range of 15°-70°, in one use-case example. In this way, the coolant is able to axially traverse the rotor as it moves radially outward to allow a greater amount of heat to be removed from the rotor.

FIG. 4 further shows a stator 440 (e.g., a multi-phase stator) of the electric machine 100. The stator 440 circumferentially surrounds a lamination assembly 441 of the rotor 415. Further, the rotor shaft 414 may be installed hydraulically in parallel to gearbox lubrication paths due to the architecture of the fluid cooling system 104. Additionally, the insert 401 may include stepped surfaces 454 which allow the coolant cavity 218 to be formed around the insert. However, other insert contours have been contemplated.

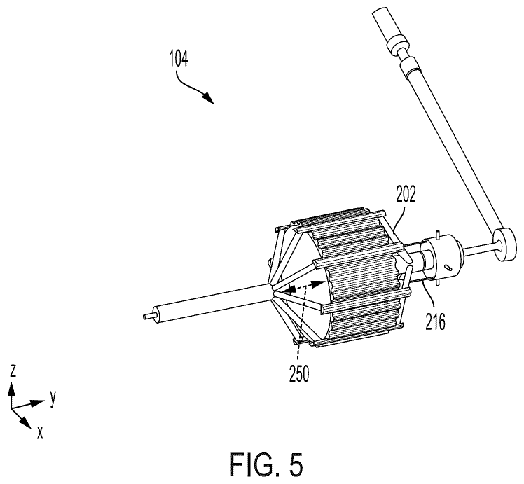

FIG. 5 shows another view of the fluid cooling system 104. The radial coolant passages 202 and air vents 216 are again illustrated. Using the air vents in the fluid cooling system, allows the system's pressure drop and pumping power over the rotor shaft to be less dependent on the speed range. Further, the fluid cooling system is capable of using lower pump power at higher motor speeds, when compared to fluid cooling system with a greater amount of air in the coolant passages. In this way, electric machine efficiency is increased.

Further, in the fluid cooling system described above with regard to FIGS. 1-6 and FIG. 7 which is discussed in greater detail herein, the number and size of the air vents may be selected to provide a desired amount of fluid flow to cool the back bearing of the electric machine. To elaborate, the number and/or size of the may be increased or decreased based on the end-use cooling targets of the motor, the size and/or construction of the back bearing, and the like.

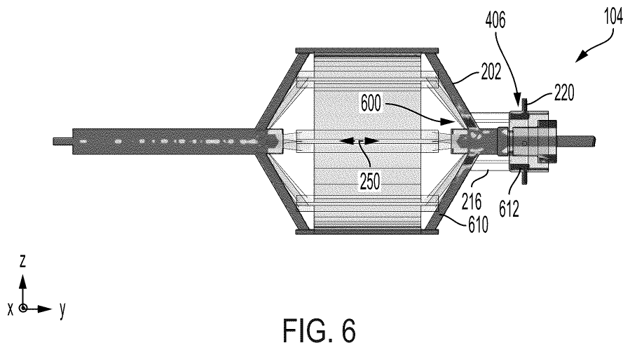

FIG. 6 shows an exemplary illustration of computational fluid dynamics (CFD) model of the oil and air in the fluid cooling system 104. The oil in the system is indicated at 610 and the air in the system is indicated at 612. As shown in FIG. 6, air is directed from an inward section 600 of the radial coolant passages 202 to the cavity 406 via the air vents 216 and then through the bearing nozzles 220. As indicated above, some oil may be mixed with this air and the bearing may therefore receive oil from the venting fluid flow in the system. Consequently, friction is reduced in the electric machine, thereby increasing machine longevity and efficiency.

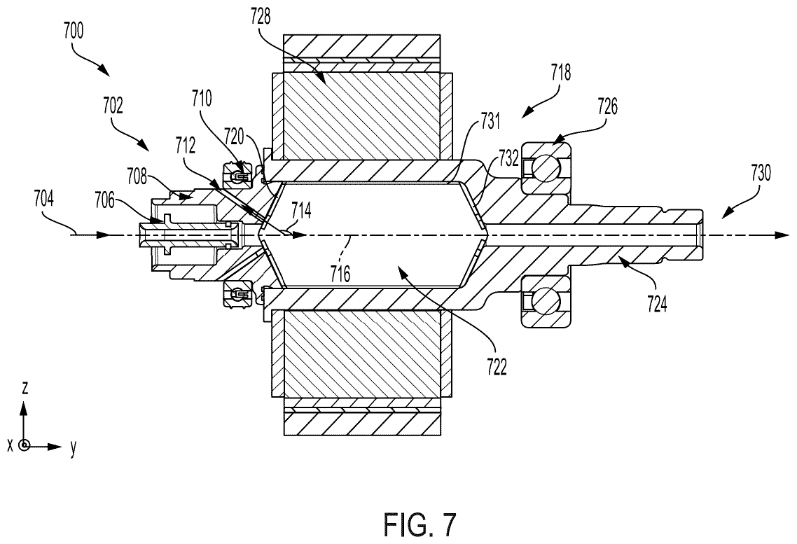

FIG. 7 shows a cross-sectional view of another exemplary electric machine 700 with a fluid cooling system 702. The fluid cooling system 702 includes an inlet 704 that is included in a static lance 706, in the illustrated example. The static lance 706 may be mounted in a housing of the electric machine. Again, the working fluid in the fluid cooling system 702 may be oil.

The static lance 706 is mated with a rotor shaft end cap 708, in the illustrated example. However, other cooling system configurations are possible. A bearing 710 may be coupled to the rotor shaft end cap 708 and a housing. The rotor shaft end cap 708 includes angled air vents 712 in the illustrated example. To elaborate, the air vents 712 form an angle 714 (e.g., an angle >90°) with a rotational axis 716 of the rotor 718. The air vents 712 are in fluidic communication with radial coolant passages 720 in a rotor shaft insert 722, similar to the other fluid cooling systems described herein. The angled air vents allow air to be effectively separated from the working fluid in the cooling system, thereby increasing cooling system efficiency.

The rotor shaft insert 722 is at least partially enclosed by a rotor shaft 724. The rotor shaft insert 722 may be constructed out of one or more polymers and has multiple inlet side radial coolant grooves axial coolant grooves, and outlet side radial coolant grooves. When the shaft insert 722 is assembled between the end cap 708 and the rotor shaft 724 the inlet side radial coolant passages 720, axial coolant passages 731, and outlet side radial coolant passages 732 are formed. The other rotor shaft inserts described herein may be constructed in a similar manner, in some examples. A bearing 726 is coupled to the rotor shaft 724 in the illustrated example. Further, a rotor core 728 is also coupled to the rotor shaft 724 in the illustrated example.

The fluid cooling system 702 further includes an outlet 730 which may be in fluidic communication with an oil sump or gearbox. The fluid cooling system 702 may have a similar oil routing scheme to the other cooling systems described herein, aside from the angled air vents. Therefore, redundant description of the cooling system's oil flow dynamics is omitted for brevity.

FIGS. 1-7 provide for a method for electric machine fluid cooling system operation where a pump in the fluid cooling system is operated to circulate a working fluid through the radial coolant passages while air is vented through the air passages. In one example, the method may further include flowing coolant from an outlet coolant passage to a gearbox, wherein the outlet coolant passage is included in the electric machine fluid cooling system.

The technical effect of the electric machine operating method described herein is to increase fluid cooling system efficiency by reducing the amount of air in the working fluid, thereby increasing electric machine efficiency.

FIGS. 1-7 are drawn approximately to scale, aside from the schematically depicted components. However, other relative component dimensions may be used, in other embodiments.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention will be further described in the following paragraphs. In one aspect, an electric machine fluid cooling system is provided that comprises an air vent in fluidic communication with a radial coolant passage; wherein the radial coolant passage is in fluidic communication with: a rotor shaft coolant passage that extends through a rotor shaft; and an inlet coolant passage that extends through a rotor shaft.

In another aspect, a method for operation of an electric machine fluid cooling system, is provided that comprises flowing cooling into an inlet coolant passage; wherein the electric machine fluid cooling system includes: an air vent in fluidic communication with a radial coolant passage; a rotor shaft coolant passage that extends through a rotor shaft; and an inlet coolant passage that is positioned in a rotor shaft; wherein the radial coolant passage is in fluidic communication with: the rotor shaft coolant passage; and that extends through a rotor shaft; and the inlet coolant passage. In one example, a central axis of the air vent may be parallel to a rotational axis of a rotor; and a central axis of the inlet coolant passage may be coaxial to the rotational axis of the rotor. In another example, the electric machine fluid cooling system may further include a bearing nozzle that extends from a cavity to a bearing cavity that is axially adjacent to a rotor shaft bearing; and the bearing nozzle may be radially aligned. Further in one example, the method may further comprise flowing coolant from an outlet coolant passage to a gearbox, wherein the outlet coolant passage is included in the electric machine fluid cooling system.

In another aspect, an electric machine fluid cooling system is provided that comprises a plurality of air vents in direct fluidic communication with a plurality of radial coolant passages; wherein the plurality of radial coolant passages are each in direct fluidic communication with one of a plurality of rotor shaft coolant passages; and wherein each of the plurality of radial coolant passages are in direct fluidic communication with an inlet coolant passage.

In any of the aspects or combinations of the aspects, the air vent may be in fluidic communication with a cavity that is positioned radially inward from a rotor shaft bearing.

In any of the aspects or combinations of the aspects, the fluid cooling system may further comprise a bearing nozzle that extends from the cavity to a bearing cavity that is axially adjacent to the rotor shaft bearing.

In any of the aspects or combinations of the aspects, the cavity may be positioned radially outward from an insert.

In any of the aspects or combinations of the aspects, the fluid cooling system may further include an outlet in fluidic communication with a gearbox.

In any of the aspects or combinations of the aspects, the fluid cooling system may further include a multi-phase stator that at least partially circumferentially surrounds the rotor shaft.

In any of the aspects or combinations of the aspects, a central axis of the air vent may be parallel to a rotational axis of the rotor.

In any of the aspects or combinations of the aspects, a working fluid in the radial coolant passages is oil.

In any of the aspects or combinations of the aspects, the plurality of radial coolant passages may be equally spaced with regard to a radial plane.

In any of the aspects or combinations of the aspects, the radial coolant passages may be inlet radial coolant passages and the electric machine fluid cooling system may further comprise outlet radial coolant passages and wherein the inlet radial coolant passages and the outlet radial coolant passages may be symmetric.

In any of the aspects or combinations of the aspects, a central axis of the air vent may be angled in relation to a rotational axis of a rotor.

In any of the aspects or combinations of the aspects, the Inlet radial coolant passages and outlet radial coolant passages may be symmetric in the electric machine fluid cooling system.

In any of the aspects or combinations of the aspects, the inlet and outlet side coolant passages may be fluidly coupled via axial coolant channels.

In any of the aspects or combinations of the aspects, the axial coolant channels may have a larger diameter than the inlet and outlet side coolant passages.

Note that the example control routines included herein can be used to control various electric machine fluid cooling systems. At least some of the control method steps disclosed herein may be stored as executable instructions in non-transitory memory and may be carried out by the machinery or system including the controller in combination with the various sensors, actuators, and/or other hardware in combination with the electronic controller. As such, the described actions, operations, and/or functions may graphically represent code to be programmed into non-transitory memory of the computer readable storage medium in a system. The various actions, operations, and/or functions illustrated may be performed in the sequence illustrated, in parallel, or in some cases omitted. Likewise, the order of processing is not necessarily required to achieve the features and advantages of the examples described herein, but is provided for case of illustration and description. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to vehicle systems that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine fluid cooling system, comprising:
an air vent in fluidic communication with a radial coolant passage;
a rotor shaft coolant passage that extends through a rotor shaft; and
an inlet coolant passage that is positioned in a rotor shaft;
wherein the radial coolant passage is in fluidic communication with:
the rotor shaft coolant passage; and
the inlet coolant passage.

2. The electric machine fluid cooling system of claim 1, wherein the air vent is in fluidic communication with a cavity that is positioned radially inward from a rotor shaft bearing.

3. The electric machine fluid cooling system of claim 2, further comprising a bearing nozzle that extends from the cavity to a bearing cavity that is axially adjacent to the rotor shaft bearing.

4. The electric machine fluid cooling system of claim 3, wherein the cavity is positioned radially outward from an insert that is included in the electric machine fluid cooling system.

5. The electric machine fluid cooling system of claim 4, a portion of the inlet coolant passage is included in a static component that is mated with the insert.

6. The electric machine fluid cooling system of claim 5, further comprising a rotary seal positioned between the insert and the static component.

7. The electric machine fluid cooling system of claim 1, further comprising an outlet coolant passage in fluidic communication with a gearbox.

8. The electric machine fluid cooling system of claim 7, wherein an electric machine housing is directly coupled to a gearbox housing.

9. The electric machine fluid cooling system of claim 1, wherein the radial coolant passages are inlet radial coolant passages and the electric machine fluid cooling system further comprises outlet radial coolant passages that are fluidly connected to the inlet radial coolant passages via axial coolant passages and wherein the inlet radial coolant passages and the outlet radial coolant passages are symmetric.

10. The electric machine fluid cooling system of claim 1, wherein a central axis of the air vent is parallel to a rotational axis of a rotor.

11. The electric machine fluid cooling system of claim 1, wherein a central axis of the air vent is angled in relation to a rotational axis of a rotor.

12. A method for operation of an electric machine fluid cooling system, comprising:
flowing coolant into an inlet coolant passage;
wherein the electric machine fluid cooling system includes:
an air vent in fluidic communication with a radial coolant passage;
a rotor shaft coolant passage that extends through a rotor shaft; and
an inlet coolant passage that is positioned in a rotor shaft;
wherein the radial coolant passage is in fluidic communication with:
the rotor shaft coolant passage; and that extends through a rotor shaft; and
the inlet coolant passage.

13. The method of claim 12, wherein:
a central axis of the air vent is parallel to a rotational axis of a rotor; and
a central axis of the inlet coolant passage is coaxial to the rotational axis of the rotor.

14. The method of claim 12, wherein:
the electric machine fluid cooling system further includes a bearing nozzle that extends from a cavity to a bearing cavity that is axially adjacent to a rotor shaft bearing; and
the bearing nozzle is radially aligned.

15. The method of claim 12, further comprising flowing coolant from an outlet coolant passage to a gearbox, wherein the outlet coolant passage is included in the electric machine fluid cooling system.

16. An electric machine fluid cooling system, comprising:
a plurality of air vents in direct fluidic communication with a plurality of radial coolant passages;
wherein the plurality of radial coolant passages are each in direct fluidic communication with one of a plurality of rotor shaft coolant passages;
wherein each of the plurality of radial coolant passages are in direct fluidic communication with an inlet coolant passage; and
wherein each of the plurality of radial coolant passages are in direct fluidic communication with an outlet coolant passage.

17. The electric machine fluid cooling system of claim 16, wherein the plurality of radial coolant passages are equally spaced with regard to a radial plane.

18. The electric machine fluid cooling system of claim 16, wherein:
a central axis of the plurality of air vents are parallel to a rotational axis of a rotor;
a central axis of the inlet coolant passage is coaxial to the rotational axis of the rotor; and
a central axis of the outlet coolant passage is coaxial to the rotational axis of the rotor.

19. The electric machine fluid cooling system of claim 16, further comprising a bearing nozzle that extends from a cavity to a bearing cavity that is axially adjacent to a rotor shaft bearing.

20. The electric machine fluid cooling system of claim 19, wherein the cavity is positioned radially outward from an insert that is included in the electric machine fluid cooling system.
